(19) United States
(12) Patent Application Publication
(10) Pub. No.: US 2017/0272800 A1
(43) Pub. Date: Sep. 21, 2017

(54) METHOD FOR BULLET SCREEN PUSHING AND ELECTRONIC DEVICE

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Ruotao WANG, Beijing (CN)

(21) Appl. No.: 15/246,738

(22) Filed: Aug. 25, 2016

Related U.S. Application Data
(63) Continuation of application No. PCT/CN2016/089346, filed on Jul. 8, 2016.

(30) Foreign Application Priority Data
Mar. 21, 2016 (CN) 201610162782.8

(51) Int. Cl. H04N 21/2668; H04N 21/258; H04N 21/25; H04N 21/4788; H04N 21/482; H04N 21/239; H04N 21/235; H04N 21/233; H04N 21/488; H04N 21/442

(52) U.S. Cl. CPC H04N 21/2668; H04N 21/4888; H04N 21/25891; H04N 21/252; H04N 21/44222; H04N 21/4826; H04N 21/2393; H04N 21/2353; H04N 21/233; H04N 21/4788

(57) ABSTRACT

A method for bullet screen pushing is disclosed. The method includes: receiving a bullet screen acquisition request for a viewed video from a target push user; acquiring a first history record of the target push user, and acquiring, via analysis, a user individual tag of the target push user according to the first history record; acquiring a second history record and/or a maker tag added by another user of at least one bullet screen maker of the video; acquiring, via analysis, a maker individual tag of the bullet screen maker according to the second history record and/or the maker tag of the bullet screen maker; matching the user individual tag of the target push user with the maker individual tag of the bullet screen maker; and pushing a bullet screen made by the bullet screen maker corresponding to the successfully matched maker individual tag to the target push user.

### CROSS REFERENCE TO RELATED APPLICATIONS

The present disclosure is a continuation application of PCT International patent application No. PCT/CN2016/089346, filed on Jul. 8, 2016, which claims priority to Chinese Patent Application No. 201610162782.8, filed with the Chinese Patent Office on Mar. 21, 2016, both of which are herein incorporated by reference in their entireties.

### TECHNICAL FIELD

The present disclosure relates to the technical field of data statistical collection and processing, and more particularly, to a method for bullet screen pushing and electronic device.

### BACKGROUND

In the bullet screen technology in the related art, text comments made by a user at the same time node are simultaneously displayed on a video frame being viewed by a user.

The current bullet screen technology implements text bullet screens and audio bullet screens (referred to audio bullets). The text bullet screens are made by typing, and the comment content may be displayed on the video frame during playing of a video. However, the audio bullet screens are made by voice recording, and the recorded comment content may be played at the corresponding time node during playing of a video.

### SUMMARY

An embodiment of the present disclosure provides a method for bullet screen pushing, including:

receiving a bullet screen acquisition request for a viewed video from a target push user;

acquiring a first history record of the target push user, and acquiring, via analysis, a user individual tag of the target push user according to the first history record;

acquiring a second history record and/or a maker tag added by another user of at least one bullet screen maker of the video;

acquiring, via analysis, a maker individual tag of the bullet screen maker according to the second history record and/or the maker tag of the bullet screen maker;

matching the user individual tag of the target push user with the maker individual tag of the bullet screen maker; and

pushing a bullet screen made by the bullet screen maker corresponding to the successfully matched maker individual tag to the target push user.

Another embodiment of the present disclosure provides an electronic device, the electronic device includes: at least one processor, and a memory. The memory is communicably connected with the at least one processor and for storing instructions executable by the at least one processor. Wherein execution of the instructions by the at least one processor causes the at least one processor to:

receive a bullet screen acquisition request for a viewed video from a target push user;

acquire a first history record of the target push user, and acquire, via analysis, a user individual tag of the target push user according to the first history record;

acquire a second history record and/or a maker tag added by another user of at least one bullet screen maker of the video, and acquiring, via analysis, a maker individual tag of the bullet screen maker according to the second history record and/or the maker tag of the bullet screen maker;

match the user individual tag of the target push user with the maker individual tag of the bullet screen maker; and

push a bullet screen made by the bullet screen maker corresponding to the successfully matched maker individual tag to the target push user.

Still another embodiment of the present disclosure provides a non-transitory computer-readable storage medium. The non-transitory computer-readable storage medium stores executable instructions, wherein when the executable instructions are executed by an electronic device, causes the electronic device to:

receive a bullet screen acquisition request for a viewed video from a target push user;

acquire a first history record of the target push user, and acquire, via analysis, a user individual tag of the target push user according to the first history record;

acquire a second history record and/or a maker tag added by another user of at least one bullet screen maker of the video, and acquiring, via analysis, a maker individual tag of the bullet screen maker according to the second history record and/or the maker tag of the bullet screen maker;

match the user individual tag of the target push user with the maker individual tag of the bullet screen maker; and

push a bullet screen made by the bullet screen maker corresponding to the successfully matched maker individual tag to the target push user.

### VIEWED BRIEF DESCRIPTION OF THE DRAWINGS

To describe embodiments of the present disclosure or the technical solution in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is a schematic flowchart illustrating a method for bullet screen pushing according to one embodiment of the present disclosure;

FIG. 2 is a schematic flowchart illustrating a method for bullet screen pushing according to another embodiment of the present disclosure;

FIG. 3 is a schematic structural diagram illustrating an apparatus for bullet screen pushing in terms of modules according to one embodiment of the present disclosure, and

FIG. 4 is a schematic structural diagram illustrating an apparatus for bullet screen pushing according to one embodiment of the present disclosure.

### DETAILED DESCRIPTION

To make the objectives, technical solutions, and advantages of the present disclosure clearer, the present disclosure is described in detail with reference to the accompanying drawings and specific embodiments.

It should be noted that, the terms “first” and “second” used in the embodiments of the present disclosure are two non-identical entities or non-identical parameters having the identical name. It is apparent that the terms “first” and “second” are given herein for illustration convenience, and shall not be construed as limiting the embodiments of the present disclosure. Such terms are not described in the following embodiments any further.

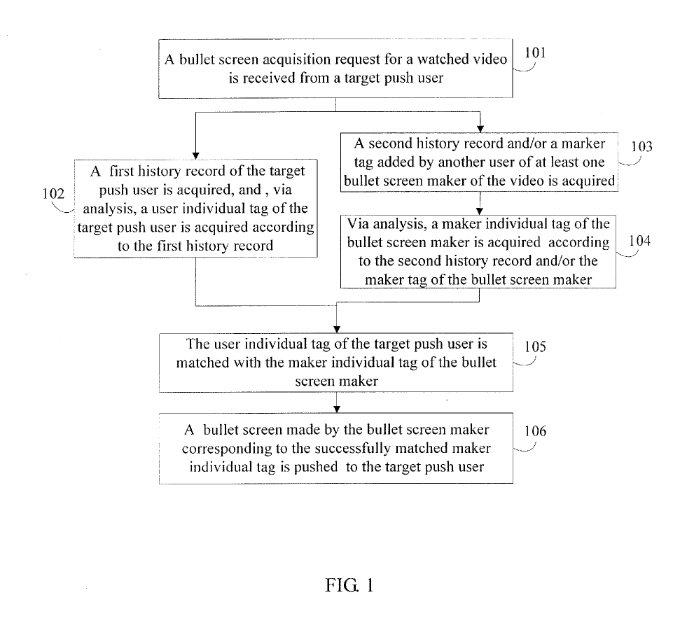

One exemplary embodiment of the present disclosure provides a method for bullet screen pushing by using which bullet screens desired by a target user may be pushed to the target user. As illustrated in FIG. 1, a schematic flowchart illustrating a method for bullet screen pushing according to one embodiment of the present disclosure is given.

The method for bullet screen pushing is applied to a server, and includes the following steps:

In step 101: a bullet screen acquisition request for a viewed video is received from a target push user; wherein generally, the bullet screen acquisition request is automatically sent by a terminal of a user to a server when the user opens a displaying interface of the video, and is used for requesting the server to push bullet screens (including text bullet screens and audio bullet screens) related to the video to the terminal; however, the bullet screen acquisition request may also be manually sent by the user, for example, clicking a button for acquiring bullet screens to send the bullet screen acquisition request;

In step 102: a first history record of the target push user is acquired, and via analysis, a user individual tag of the target push user is acquired according to the first history record; wherein the first history record may include any history operation record of the target push user, for example, a history viewing record, a created album and the like; and the user individual tag is a tag which may be acquired, via analysis, from the first history record and represents individuality and preference of the target push user, and generally the user individual tag includes at least two tags;

In step 103: a second history record and/or a maker tag added by another user of at least one bullet screen maker of the video is acquired; wherein likewise, the second history record may include any history operation record of the target push user, for example, a history viewing record, a created album and the like;

In step 104: via analysis, a maker individual tag of the bullet screen maker is acquired according to the second history record and/or the maker tag of the bullet screen maker; wherein the maker individual tag is a tag which may be acquired, via analysis, from the second history record and represents individuality and preference of the bullet screen maker, and generally the maker individual tag includes at least two tags;

In step 105: the user individual tag of the target push user is matched with the maker individual tag of the bullet screen maker; and

In step 106: a bullet screen made by the bullet screen maker corresponding to the successfully matched maker individual tag is pushed to the target push user.

As seen from the above embodiment, with the method for bullet screen pushing according to the embodiments of the present disclosure, a user individual tag representing preference of the user may be extracted from a first history record of a target push user, the user individual tag is matched with a maker individual tag of a bullet screen maker, and bullet screens made by the successfully matched bullet screen maker are pushed to the user. In this way, the user may watch and hear his or her interest bullet screens, rather than pushing general bullet screens to the target push user, thereby improving pertinence of bullet screen playing, and enhancing user experience.

Further, in some exemplary embodiments, the first history record includes a first history viewing record and a first viewing interaction record of the target push user; wherein the first history viewing record includes videos which have been viewed by the target push user, including movies, short films, TV drama programs, entertainment programs and the like, and viewing time, durations and the like of these videos; and the first viewing interaction record refers to interactive operations performed by the target push user when viewing videos or using video software and video websites, for example, operations of creating interested albums, giving a like to videos, making comments and the like; and

the step of acquiring, via analysis, a user individual tag of the target push user according to the first history record includes:

respectively acquiring, via analysis, a user viewing record individual tag and a user interaction record individual tag of the target push user from the first history viewing record and the first viewing interaction record; wherein the user viewing record individual tag is a tag related to the viewing preference of the user acquired, via analysis, from the first history viewing record, and the user interaction record individual tag a tag related to the interaction preference of the user acquired, via analysis, from the first viewing interaction record; and

acquiring a user individual tag including the user viewing record individual tag and the user viewing interaction record tag.

According to the above embodiment, the user individual tag includes tags related to the viewing preference and interaction preference of the target push user, which enriches the content of the user individual tag and more thoroughly reflects the preference of the target push user.

In some other exemplary embodiments, the second history record includes a second history viewing record and a second viewing interaction record of the bullet screen maker; wherein the second history viewing record includes videos which have been viewed by the bullet screen maker, including movies, short films, TV drama programs, entertainment programs and the like, and viewing time, durations and the like of these videos; and the second viewing interaction record refers to interactive operations performed by the bullet screen maker when viewing videos or using video software and video websites, for example, operations of creating interested albums, giving a like to videos, making comments and the like; and

the step of acquiring, via analysis, a maker individual tag of the bullet screen maker according to the second history record and the maker tag of the bullet screen maker includes:

respectively acquiring, via analysis, a user viewing record individual tag and a user interaction record individual tag of the bullet screen maker from second first history viewing record and the second viewing interaction record; wherein the maker viewing record individual tag is a tag related to the viewing preference of the bullet screen maker acquired, via analysis, from the first history viewing record, and the maker interaction record individual tag a tag related to the interaction preference of the bullet screen maker acquired, via analysis, from the second viewing interaction record; and

acquiring a maker individual tag including the maker viewing record individual tag, the maker interaction record individual tag and the maker tag.

According to the above embodiment, the maker individual tag includes tags related to the viewing preference and interaction preference of the bullet screen maker, which enriches the content of the maker individual tag and more thoroughly reflects the preference of the bullet screen maker.

In some exemplary embodiments, the first history viewing record of the target push user includes videos viewed by the target push user; the first viewing interaction record includes albums created by the target push user, comments made by the target push user and users to whom the target push user gives a like; and

the step of acquiring, via analysis, a user individual tag of the target push user according to the first history record may further includes the following steps:

acquiring video tags of the videos viewed by the target push user, extracting, from the video tags, a video tag with an occurrence frequency higher than a first predetermined frequency, and using the extracted video tag as a user individual video tag;

herein, the viewed videos may be videos which have been viewed with a predetermined period of time, for example, videos which have been viewed within 30 days; for the sake of accuracy, videos within a longer period of time may be selected; however, a video which has been viewed within a later period of time may be assigned a large weight, and a video which has been viewed within an earlier period of time may be assigned a small weight, to reflect the interest of the target push user at this stage; the video tags includes a tag added by the target push user and a tag added by another user, that is, all the tags added to the user, and may also include a type tag added by a service provider in advance to the videos, for example, imperial-harem competing plays, science fictions, funny plays and the like; the first predetermined frequency may be predefined, or may be self-defined by the user, for example, 5 times within 30 days;

extracting an album tag according to the albums created by the target push user, and using the extracted album tag as a user individual album tag;

the album herein refers to an album created by the user according to his or her interested video types, for example, American comedies, Korea soap operas and the like; since the album created by the user himself or herself better reflects his or her interests, the tag of the album created by the target push user may be used as an individuality criterion of an account of the target push user, for example, improving the weight of the user individual album tag; in addition, according to the creation date and update date of the album, the album tag may also accordingly serve as a criterion for different weights to corresponding user individual album tags;

acquiring the comments made by the target push user, extracting a comment tag with an occurrence frequency higher than a second predetermined frequency, and using the extracted comment tag as a user individual comment tag;

herein, the released comments may be comments made and released within a predetermined period of time, for example, comments released within 30 days; for the sake of accuracy, a longer period of time may also be selected; however, a comment which has been made within a later period of time may be assigned a large weight, and a comment which has been made within an earlier period of time may be assigned a small weight, to reflect the interest of the target push user at this stage; the second predetermined frequency may be predefined, or may be self-defined by the user, for example, 2 times within 30 days;

acquiring user tags of the users to which the target push user gives a like, and using the acquired user tags as a user individual like-giving tag;

herein, the users to whom the target push user gives a like have their individual tags which come from the types of content released by these users, likewise including viewed videos, created albums, made comments; or the individual tags of these users may also be tags added by other users inclusive of the target push user or the tags added by these users themselves;

acquiring a user individual tag including the user individual video tag, the user individual album tag, the user individual comment tag and the user individual like-giving tag.

According to the above embodiment, the user individual tag includes tags better reflecting the preference of the target push user, which enriches the content of the user individual tag and more thoroughly reflects the preference of the target push user.

In some exemplary embodiments, the second history viewing record of the bullet screen maker includes videos viewed by the bullet screen maker; the second viewing interaction record includes albums created by the bullet screen maker, comments made by the bullet screen maker and users to whom the bullet screen maker gives a like; the maker tag added by another user includes an individual tag and a work tag, wherein the individual tag is a tag of the bullet screen maker, the work tag of work of the bullet screen maker, and both the individual tag and the work tag may be tags added by the bullet screen maker himself or herself or tags added by another user to the bullet screen maker; and

the step of acquiring, via analysis, a maker individual tag of the bullet screen maker according to the second history record and the maker tag of the bullet screen maker may further includes the following steps:

acquiring video tags of the videos viewed by bullet screen maker, extracting, from the video tags, a video tag with an occurrence frequency higher than a third predetermined frequency, and using the extracted video tag as a maker individual video tag;

herein, the viewed videos may be videos which have been viewed with a predetermined period of time, for example, videos which have been viewed within 30 days; for the sake of accuracy, videos within a longer period of time may be selected; however, a video which has been viewed within a later period of time may be assigned a large weight, and a video which has been viewed within an earlier period of time may be assigned a small weight, to reflect the interest of the bullet screen maker at this stage; the video tags includes a tag added by the bullet screen maker and a tag added by another user, that is, all the tags added to the user, and may also include a type tag added by a service provider in advance to the videos, for example, imperial-harem competing plays, science fictions, funny plays and the like; the third predetermined frequency may be predefined, or may be self-defined by the user, for example, 5 times within 30 days, which may be equal to or not equal to the first predetermined frequency according to the actual needs;

extracting an album tag according to the albums created by bullet screen maker, and using the extracted album tag as a maker individual album tag;

the album herein refers to an album created by the bullet screen maker according to his or her interested video types, for example, American comedies, Korea soap operas and the like; since the album created by the bullet screen maker himself or herself better reflects his or her interests, the tag of the album created by the bullet screen maker may be used as an individuality criterion of an account of the bullet screen maker, for example, improving the weight of the maker individual album tag; in addition, according to the creation date and update date of the album, the album tag may also accordingly serve as a criterion for different weights to corresponding maker individual album tags;

acquiring the comments made by bullet screen maker, extracting a comment tag with an occurrence frequency higher than a second predetermined frequency, and using the extracted comment tag as a maker individual comment tag;

herein, the released comments may be comments made and released within a predetermined period of time, for example, comments released within 30 days; for the sake of accuracy, a longer period of time may also be selected; however, a comment which has been made within a later period of time may be assigned a large weight, and a comment which has been made within an earlier period of time may be assigned a small weight, to reflect the interest of the bullet screen maker at this stage; the second predetermined frequency may be predefined, or may be self-defined by the bullet screen maker, for example, 2 times within 30 days, which may be equal to or not equal to the second predetermined frequency according to the actual needs;

acquiring user tags of the users to which the bullet screen maker gives a like, and using the acquired user tags as a maker individual like-giving tag;

herein, likewise, the users to whom the bullet screen maker gives a like have their individual tags which come from the types of content released by these users, likewise including viewed videos, created albums, made comments; or the individual tags of these users may also be tags added by other users inclusive of bullet screen maker or the tags added by these users themselves; and

acquiring a maker individual tag including the maker individual video tag, the maker individual album tag, the maker individual comment tag, the maker individual like-giving tag, the individual tag, the work tag and the maker tag.

In addition, when the bullet screen maker is a celebrity or a famous star, the bullet screen maker is generally invited by the service provider to make bullet screens. Therefore, the maker individual tags of this type of bullet screen makers further includes maker tags defined by the service provider for them. For example, a comic dialogist may be assigned a tag such as “traditional Chinese humor”, “comic dialog” and the like, and a young actor may be assigned a tag such as “youth”, “fashion” and the like.

According to the above embodiment, the maker individual tag includes tags better reflecting the preference of the bullet screen maker, which enriches the content of the maker individual tag and more thoroughly reflects the preference of the bullet screen maker.

Further, in some exemplary embodiments, the step of matching the user individual tag of the target push user with the maker individual tag of the bullet screen maker includes:

comparing one by one the user individual tags of the target push user with the maker individual tags of the bullet screen maker;

when the quantity of same maker individual tags of the bullet screen maker and user individual tags of the target push user is greater than or equal to a predetermined quantity threshold, judge that the maker individual tags of the bullet screen maker match with the user individual tags of the target push user; wherein there may be two or more than two predetermined quantity thresholds, and nevertheless, the quantity of predetermined quantity thresholds may also be predefined by the user according to the actual needs.

In some other exemplary embodiments, the step of pushing a bullet screen made by the bullet screen maker corresponding to the successfully matched maker individual tag to the target push user includes:

sorting, according to the quantity of maker individual tags which successfully match with the user individual tags of the target push user, in a descending order bullet screens made by the bullet screen maker corresponding to the successfully matched maker individual tags; and

successively pushing the sorted bullet screens to the target push user.

For example, if the quantities of individual tags of the target push user same as the successfully matched bullet screen makers A, B and C are respectively 5, 4 and 3, the bullet screens made by the bullet screen maker A may be firstly pushed, then the bullet screens made by the bullet screen maker B may be pushed, and finally the bullet screens made by the bullet screen maker C may be pushed. However, when the bullet screens made by these three bullet screen makers appear at the adjacent or the same time points, the bullet screens may be pushed in a sort of A to B to C. As such, the pushing of the bullet screens achieves pertinence.

In addition, all the user individual tags may be sorted according to the weights of these user individual tags, and the tags ranking top are pushed to the user according to the weights of the tags from the maker individual tags which are same as the user individual tags.

For example, the user individual tags include a, b and c, and the weights thereof are respectively 0.5, 0.3 and 0.2, whereas the maker individual tags of the bullet screen maker A are a and d, the maker individual tags of the bullet screen maker B are b and e, the maker individual tags of the bullet screen maker C are c and f. Assume that the predetermined quantity threshold is 1, the bullet screen makers A, B and C successfully match with the target push user, and A→a→0.5, B→b→0.3, C→c→0.2 according to the weights of the same tags. Therefore, during pushing, bullet screens are pushed to the target push user in a sort of A to B to C. As such, pertinence of the pushing of the bullet screens is further improved.

In some exemplary embodiments, when the bullet screen made by the bullet screen maker to the video is a text bullet screen, the step of pushing a bullet screen made by the bullet screen maker corresponding to the successfully matched maker individual tag to the target push user further includes:

matching text content of the text bullet screen made by the successfully matched bullet screen maker to the video with a tag of the video; and

pushing the text bullet screen corresponding to the successfully matched text content to the target push user.

According to the above embodiment, text bullet screens closer to the subject of the video are pushed, thereby reducing spammed content.

In some other exemplary embodiments, when the bullet screen made by the bullet screen maker to the video is an audio bullet screen, the step of pushing a bullet screen made by the bullet screen maker corresponding to the successfully matched maker individual tag to the target push user further includes:

converting audio content of the audio bullet screen made by the successfully matched bullet screen maker to the video into text content;

matching the text content acquired via conversion with a tag of the video; and

pushing the audio bullet screen corresponding to the successfully matched text content to the target push user.

According to the above embodiment, audio bullet screens closer to the subject of the video are pushed, thereby reducing spammed content.

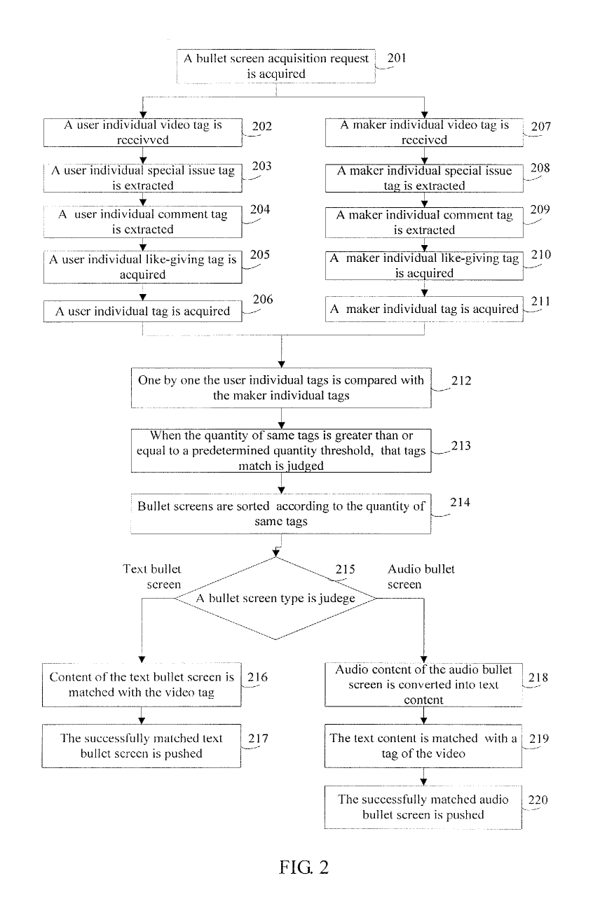

The present disclosure further provides another embodiment illustrating the bullet screen method. As illustrated in FIG. 2, a schematic flowchart illustrating a method for bullet screen pushing according to another embodiment of the present disclosure is given.

The method for bullet screen pushing includes the following steps:

In step 201: a bullet screen acquisition request for a viewed video is received from a target push user;

In step 202: video tags of the videos viewed by the target push user, are acquired, from the video tags, a video tag with an occurrence frequency higher than a first predetermined frequency is extracted, and the extracted video tag is used as a user individual video tag;

In step 203: an album tag according to the albums created by the target push user is extracted, and the extracted album tag is used as a user individual album tag;

In step 204: the comments made by the target push user are acquired, a comment tag with an occurrence frequency higher than a second predetermined frequency is extracted, and the extracted comment tag is used as a user individual comment tag;

In step 205: user tags of the users to which the target push user gives a like are acquired, and the acquired user tags are used as a user individual like-giving tag;

In step 206: a user individual tag including the user individual video tag, the user individual album tag, the user individual comment tag and the user individual like-giving tag are acquired;

In step 207: video tags of the videos viewed by bullet screen maker are acquired, from the video tags, a video tag with an occurrence frequency higher than a third predetermined frequency is extracted, and the extracted video tag is used as a maker individual video tag;

In step 208: an album tag according to the albums created by bullet screen maker is extracted, and the extracted album tag is used as a maker individual album tag;

In step 209: the comments made by bullet screen maker are acquired, a comment tag with an occurrence frequency higher than a second predetermined frequency is extracted, and the extracted comment tag is used as a maker individual comment tag;

In step 210: user tags of the users to which the bullet screen maker gives a like are acquired, and the acquired user tags are used as a maker individual like-giving tag;

In step 211: a maker individual tag including the maker individual video tag, the maker individual album tag, the maker individual comment tag, the maker individual like-giving tag, the individual tag, the work tag and the maker tag are acquired.

In step 212: one by one the user individual tags of the target push user is compared with the maker individual tags of the bullet screen maker; and

In step 213: when the quantity of same maker individual tags of the bullet screen maker and user individual tags of the target push user is greater than or equal to a predetermined quantity threshold, that the maker individual tags of the bullet screen maker match with the user individual tags of the target push user is judged;

In step 214: according to the quantity of maker individual tags which successfully match with the user individual tags of the target push user, in a descending order bullet screens made by the bullet screen maker corresponding to the successfully matched maker individual tags are sorted; and

In step 215: a bullet screen type is judged;

In step 216: when the bullet screen made by the bullet screen maker to the video is a text bullet screen, text content of the text bullet screen made by the successfully matched bullet screen maker to the video is matched with a tag of the video;

In step 217: the text bullet screen corresponding to the successfully matched text content is pushed to the target push user;

In step 218: when the bullet screen made by the bullet screen maker to the video is an audio bullet screen, audio content of the audio bullet screen made by the successfully matched bullet screen maker to the video is converted into text content;

In step 219: the text content acquired via conversion is matched with a tag of the video; and

In step 210: the audio bullet screen corresponding to the successfully matched text content is pushed to the target push user.

As seen from the above embodiment, with the method for bullet screen pushing according to the embodiments of the present disclosure, a user individual tag representing preference of the user may be extracted from a first history record of a target push user, the user individual tag is matched with a maker individual tag of a bullet screen maker, and bullet screens made by the successfully matched bullet screen maker are pushed to the user. In this way, the user may watch and hear his or her interest bullet screens, rather than pushing general bullet screens to the target push user, thereby improving pertinence of bullet screen playing, and enhancing user experience.

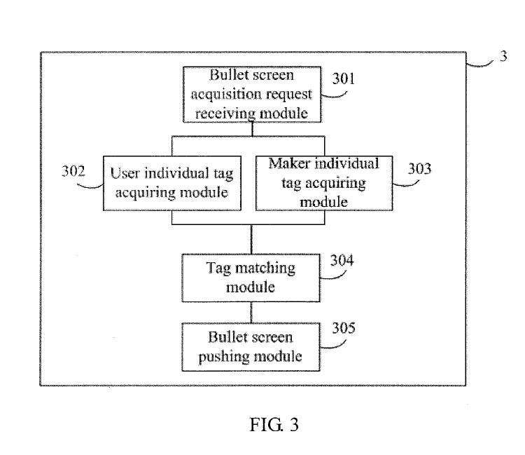

One exemplary embodiment of the present disclosure provides an apparatus for bullet screen pushing by using which bullet screens desired by a target user may be pushed to the target user. As illustrated in FIG. 3, a schematic structural diagram illustrating an apparatus for bullet screen pushing in terms of modules according to one embodiment of the present disclosure is given.

The apparatus for bullet screen pushing includes:

a bullet screen acquisition request receiving module 301, configured to receive a bullet screen acquisition request for a viewed video from a target push user; wherein generally, the bullet screen acquisition request is automatically sent by a terminal of a user to a server when the user opens a displaying interface of the video, and is used for requesting the server to push bullet screens (including text bullet screens and audio bullet screens) related to the video to the terminal; however, the bullet screen acquisition request may also be manually sent by the user, for example, clicking a button for acquiring bullet screens to send the bullet screen acquisition request;

a user individual tag acquiring module 302, configured to acquire a first history record of the target push user, and acquire, via analysis, a user individual tag of the target push user according to the first history record; wherein the first history record may include any history operation record of the target push user, for example, a history viewing record, a created album and the like; and the user individual tag is a tag which may be acquired, via analysis, from the first history record and represents individuality and preference of the target push user, and generally the user individual tag includes at least two tags;

a maker individual tag acquiring module 303, configured to acquire a second history record and/or a maker tag added by another user of at least one bullet screen maker of the video, and acquire, via analysis, a maker individual tag of the bullet screen maker according to the second history record and/or the maker tag of the bullet screen maker; wherein likewise, the second history record may include any history operation record of the bullet screen maker, for example, a history viewing record, a created album and the like; and the user individual tag is a tag which may be acquired, via analysis, from the second history record and represents individuality and preference of the bullet screen maker, and generally the maker individual tag includes at least two tags;

a tag matching module 304, configured to match the user individual tag of the target push user with the maker individual tag of the bullet screen maker; and

a bullet screen pushing module 305, configured to push a bullet screen made by the bullet screen maker corresponding to the successfully matched maker individual tag to the target push user.

As seen from the above embodiment, with the apparatus for bullet screen pushing according to the embodiments of the present disclosure, a user individual tag representing preference of the user may be extracted from a first history record of a target push user, the user individual tag is matched with a maker individual tag of a bullet screen maker, and bullet screens made by the successfully matched bullet screen maker are pushed to the user. In this way, the user may watch and hear his or her interest bullet screens, rather than pushing general bullet screens to the target push user, thereby improving pertinence of bullet screen playing, and enhancing user experience.

Further, in some exemplary embodiments, the first history record includes a first history viewing record and a first viewing interaction record of the target push user; wherein the first history viewing record includes videos which have been viewed by the target push user, including movies, short films, TV drama programs, entertainment programs and the like, and viewing time, durations and the like of these videos; and the first viewing interaction record refers to interactive operations performed by the target push user when viewing videos or using video software and video websites, for example, operations of creating interested albums, giving a like to videos, making comments and the like; and

the user individual tag acquiring module 302 is specifically configured to:

respectively acquire, via analysis, a user viewing record individual tag and a user interaction record individual tag of the target push user from the first history viewing record and the first viewing interaction record; wherein the user viewing record individual tag is a tag related to the viewing preference of the user acquired, via analysis, from the first history viewing record, and the user interaction record individual tag a tag related to the interaction preference of the user acquired, via analysis, from the first viewing interaction record; and

acquire a user individual tag including the user viewing record individual tag and the user viewing interaction record tag.

According to the above embodiment, the user individual tag includes tags related to the viewing preference and interaction preference of the target push user, which enriches the content of the user individual tag and more thoroughly reflects the preference of the target push user.

In some other exemplary embodiments, the second history record includes a second history viewing record and a second viewing interaction record of the bullet screen maker; wherein the second history viewing record includes videos which have been viewed by the bullet screen maker, including movies, short films, TV drama programs, entertainment programs and the like, and viewing time, durations and the like of these videos; and the second viewing interaction record refers to interactive operations performed by the bullet screen maker when viewing videos or using video software and video websites, for example, operations of creating interested albums, giving a like to videos, making comments and the like; and

the maker individual tag acquiring module 303 is specifically configured to:

respectively acquire, via analysis, a user viewing record individual tag and a user interaction record individual tag of the bullet screen maker from second first history viewing record and the second viewing interaction record; wherein the maker viewing record individual tag is a tag related to the viewing preference of the bullet screen maker acquired, via analysis, from the first history viewing record, and the maker interaction record individual tag a tag related to the interaction preference of the bullet screen maker acquired, via analysis, from the second viewing interaction record; and

acquire a maker individual tag including the maker viewing record individual tag, the user interaction record individual tag and the maker tag.

According to the above embodiment, the maker individual tag includes tags related to the viewing preference and interaction preference of the bullet screen maker, which enriches the content of the maker individual tag and more thoroughly reflects the preference of the bullet screen maker.

In some exemplary embodiments, the first history viewing record of the target push user includes videos viewed by the target push user; the first viewing interaction record includes albums created by the target push user, comments made by the target push user and users to whom the target push user gives a like;

the user individual tag acquiring module 302 is specifically configured to:

acquire video tags of the videos viewed by the target push user, extract, from the video tags, a video tag with an occurrence frequency higher than a first predetermined frequency, and use the extracted video tag as a user individual video tag;

herein, the viewed videos may be videos which have been viewed with a predetermined period of time, for example, videos which have been viewed within 30 days; for the sake of accuracy, videos within a longer period of time may be selected; however, a video which has been viewed within a later period of time may be assigned a large weight, and a video which has been viewed within an earlier period of time may be assigned a small weight, to reflect the interest of the target push user at this stage; the video tags includes a tag added by the target push user and a tag added by another user, that is, all the tags added to the user, and may also include a type tag added by a service provider in advance to the videos, for example, imperial-harem competing plays, science fictions, funny plays and the like; the first predetermined frequency may be predefined, or may be self-defined by the user, for example, 5 times within 30 days;

extract an album tag according to the albums created by the target push user, and use the extracted album tag as a user individual album tag;

the album herein refers to an album created by the user according to his or her interested video types, for example, American comedies, Korea soap operas and the like; since the album created by the user himself or herself better reflects his or her interests, the tag of the album created by the target push user may be used as an individuality criterion of an account of the target push user, for example, improving the weight of the user individual album tag; in addition, according to the creation date and update date of the album, the album tag may also accordingly serve as a criterion for different weights to corresponding user individual album tags;

acquire the comments made by the target push user, extract a comment tag with an occurrence frequency higher than a second predetermined frequency, and use the extracted comment tag as a user individual comment tag;

herein, the released comments may be comments made and released within a predetermined period of time, for example, comments released within 30 days; for the sake of accuracy, a longer period of time may also be selected; however, a comment which has been made within a later period of time may be assigned a large weight, and a comment which has been made within an earlier period of time may be assigned a small weight, to reflect the interest of the target push user at this stage; the second predetermined frequency may be predefined, or may be self-defined by the user, for example, 2 times within 30 days;

acquire user tags of the users to which the target push user gives a like, and use the acquired user tags as a user individual like-giving tag;

herein, the users to whom the target push user gives a like have their individual tags which come from the types of content these users release, likewise including viewed videos, created albums, made comments; or the individual tags of these users may also be tags added by other users inclusive of the target push users or the tags added by these users themselves; and

acquire a user individual tag including the user individual video tag, the user individual album tag, the user individual comment tag and the user individual like-giving tag.

According to the above embodiment, the user individual tag includes tags better reflecting the preference of the target push user, which enriches the content of the user individual tag and more thoroughly reflects the preference of the target push user.

In some exemplary embodiments, the second history viewing record of the bullet screen maker includes videos viewed by the bullet screen maker; the second viewing interaction record includes albums created by the bullet screen maker, comments made by the bullet screen maker and users to whom the bullet screen maker gives a like; the maker tag added by another user includes an individual tag and a work tag, wherein the individual tag is a tag of the bullet screen maker, the work tag of work of the bullet screen maker, and both the individual tag and the work tag may be tags added by the bullet screen maker himself or herself or tags added by another user to the bullet screen maker; and

the maker individual tag acquiring module 303 is specifically configured to:

acquire video tags of the videos viewed by bullet screen maker, extract, from the video tags, a video tag with an occurrence frequency higher than a third predetermined frequency, and use the extracted video tag as a maker individual video tag;

herein, the viewed videos may be videos which have been viewed with a predetermined period of time, for example, videos which have been viewed within 30 days; for the sake of accuracy, videos within a longer period of time may be selected; however, a video which has been viewed within a later period of time may be assigned a large weight, and a video which has been viewed within an earlier period of time may be assigned a small weight, to reflect the interest of the bullet screen maker at this stage; the video tags includes a tag added by the bullet screen maker and a tag added by another user, that is, all the tags added to the user, and may also include a type tag added by a service provider in advance to the videos, for example, imperial-harem competing plays, science fictions, funny plays and the like; the third predetermined frequency may be predefined, or may be self-defined by the user, for example, 5 times within 30 days, which may be equal to or not equal to the first predetermined frequency according to the actual needs;

extract an album tag according to the albums created by bullet screen maker, and use the extracted album tag as a maker individual album tag;

the album herein refers to an album created by the bullet screen maker according to his or her interested video types, for example, American comedies, Korea soap operas and the like; since the album created by the bullet screen maker himself or herself better reflects his or her interests, the tag of the album created by the bullet screen maker may be used as an individuality criterion of an account of the bullet screen maker, for example, improving the weight of the maker individual album tag; in addition, according to the creation date and update date of the album, the album tag may also accordingly serve as a criterion for different weights to corresponding maker individual album tags;

acquire the comments made by bullet screen maker, extract a comment tag with an occurrence frequency higher than a second predetermined frequency, and use the extracted comment tag as a maker individual comment tag;

herein, the released comments may be comments made and released within a predetermined period of time, for example, comments released within 30 days; for the sake of accuracy, a longer period of time may also be selected; however, a comment which has been made within a later period of time may be assigned a large weight, and a comment which has been made within an earlier period of time may be assigned a small weight, to reflect the interest of the bullet screen maker at this stage; the second predetermined frequency may be predefined, or may be self-defined by the bullet screen maker, for example, 2 times within 30 days, which may be equal to or not equal to the second predetermined frequency according to the actual needs;

acquire user tags of the users to which the bullet screen maker gives a like, and use the acquired user tags as a maker individual like-giving tag;

herein, likewise, the users to whom the bullet screen maker gives a like have their individual tags which come from the types of content released by these users, likewise including viewed videos, created albums, made comments; or the individual tags of these users may also be tags added by other users inclusive of bullet screen maker or the tags added by these users themselves; and

acquire a maker individual tag including the maker individual video tag, the maker individual album tag, the maker individual comment tag, the maker individual like-giving tag, the individual tag, the work tag and the maker tag.

In addition, when the bullet screen maker is a celebrity or a famous star, the bullet screen maker is generally invited by the service provider to make bullet screens. Therefore, the maker individual tags of this type of bullet screen makers further includes maker tags defined by the service provider for them. For example, a comic dialogist may be assigned a tag such as “traditional Chinese humor”, “comic dialog” and the like, and a young actor may be assigned a tag such as “youth”, “fashion” and the like.

According to the above embodiment, the maker individual tag includes tags better reflecting the preference of the bullet screen maker, which enriches the content of the maker individual tag and more thoroughly reflects the preference of the bullet screen maker.

Further, in some exemplary embodiments, the tag matching module 304 is specifically configured to:

compare one by one the user individual tags of the target push user with the maker individual tags of the bullet screen maker; and

when the quantity of same maker individual tags of the bullet screen maker and user individual tags of the target push user is greater than or equal to a predetermined quantity threshold, judge that the maker individual tags of the bullet screen maker match with the user individual tags of the target push user; wherein there may be two or more than two predetermined quantity thresholds, and nevertheless, the quantity of predetermined quantity thresholds may also be predefined by the user according to the actual needs.

In some other exemplary embodiments, the bullet screen pushing module 305 is specifically configured to:

sort, according to the quantity of maker individual tags which successfully match with the user individual tags of the target push user, in a descending order bullet screens made by the bullet screen maker corresponding to the successfully matched maker individual tags; and

successively push the sorted bullet screens to the target push user.

For example, if the quantities of individual tags of the target push user same as the successfully matched bullet screen makers A, B and C are respectively 5, 4 and 3, the bullet screens made by the bullet screen maker A may be firstly pushed, then the bullet screens made by the bullet screen maker B may be pushed, and finally the bullet screens made by the bullet screen maker C may be pushed. However, when the bullet screens made by these three bullet screen makers appear at the adjacent or the same time points, the bullet screens may be pushed in a sort of A to B to C. As such, the pushing of the bullet screens achieves pertinence.

In addition, all the user individual tags may be sorted according to the weights of these user individual tags, and the tags ranking top are pushed to the user according to the weights of the tags from the maker individual tags which are same as the user individual tags.

For example, the user individual tags include a, b and c, and the weights thereof are respectively 0.5, 0.3 and 0.2, whereas the maker individual tags of the bullet screen maker A are a and d, the maker individual tags of the bullet screen maker B are b and e, the maker individual tags of the bullet screen maker C are c and f. Assume that the predetermined quantity threshold is 1, the bullet screen makers A, B and C successfully match with the target push user, and A→a→0.5, B→b→0.3, C→c→0.2 according to the weights of the same tags. Therefore, during pushing, bullet screens are pushed to the target push user in a sort of A to B to C. As such, pertinence of the pushing of the bullet screens is further improved.

In some exemplary embodiments, when the bullet screen made by the bullet screen maker to the video is a text bullet screen, the bullet screen pushing module 305 is specifically configured to:

match text content of the text bullet screen made by the successfully matched bullet screen maker to the video with a tag of the video; and

push the text bullet screen corresponding to the successfully matched text content to the target push user.

According to the above embodiment, text bullet screens closer to the subject of the video are pushed, thereby reducing spammed content.

In some other exemplary embodiments, when the bullet screen made by the bullet screen maker to the video is an audio bullet screen, the bullet screen pushing module 305 is specifically configured to:

convert audio content of the audio bullet screen made by the successfully matched bullet screen maker to the video into text content;

match the text content acquired via conversion with a tag of the video; and

push the audio bullet screen corresponding to the successfully matched text content to the target push user.

According to the above embodiment, audio bullet screens closer to the subject of the video are pushed, thereby reducing spammed content.

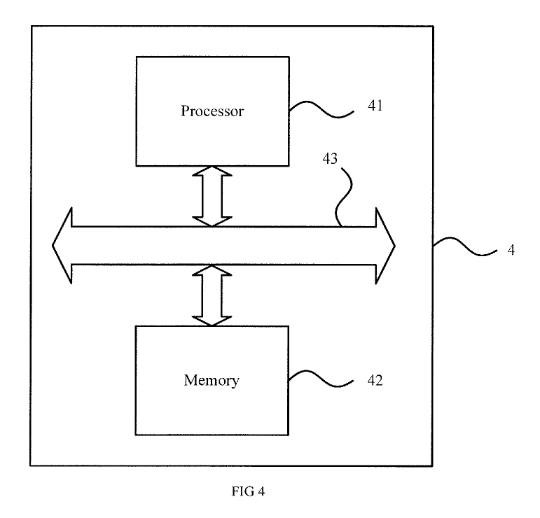

In still another aspect, the embodiments of the present disclosure further provide an apparatus for bullet screen pushing. FIG. 4 is a schematic structural diagram of an apparatus for bullet screen pushing according to one embodiment of the present disclosure. As illustrated in FIG. 4, the apparatus for bullet screen pushing 4 includes: a processor 41, a memory 42 and a bus system 43. The processor 41 and the memory 42 are connected to each other via the bus system 43, the memory 42 is configured to store instructions, and the processor 41 is configured to execute the instructions stored in the memory 42 to:

receive a bullet screen acquisition request for a viewed video from a target push user;

acquire a first history record of the target push user, and acquire, via analysis, a user individual tag of the target push user according to the first history record;

acquire a second history record and/or a maker tag added by another user of at least one bullet screen maker of the video;

acquire, via analysis, a maker individual tag of the bullet screen maker according to the second history record and/or the maker tag of the bullet screen maker;

match the user individual tag of the target push user with the maker individual tag of the bullet screen maker; and

push a bullet screen made by the bullet screen maker corresponding to the successfully matched maker individual tag to the target push user.

The memory 42 of the apparatus for bullet screen 4 may be a non-volatile computer readable storage medium, which is configured to store computer executable instructions. When the instructions are executed by one or a plurality of central processors, for example, a processor may be caused to perform the steps in the above method embodiments, for example, steps 101 to 106 illustrated in FIG. 1, or steps 201 to 220 illustrated in FIG. 2, or the processor may be caused to implement the functions of the units in the above apparatus embodiments, for example, the functions of units 301 to 306 illustrated in FIG. 3. The computer executable instructions may also be stored and/or transmitted in any non-volatile computer readable storage medium, such that these instructions are used by an instruction executing system, apparatus or device, or used in combination with the instruction executing system, apparatus or device. The instruction executing system, apparatus or device may be, for example, a computer-based system, a system includes a processor or another system capable of acquiring instructions from the instruction executing system, apparatus or device and executing the instructions. For the purpose of this specification, the “non-volatile computer readable storage medium” may be any tangible medium including or storing computer executable instructions. The computer executable instructions may be used by the instruction executing system, apparatus or device, or used in combination with the executing system, apparatus or device. The non-volatile computer readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

It should be understood that in the embodiments of the present application, the processor 41 may be a central processing unit (CPU). The processor 41 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 43 may further include a power bus, a control bus, a state signal bus and the like. However, for clarity of description, various buses are all marked as the bus system 43.

In the embodiments of the present disclosure, the apparatus for bullet screen is not limited to the components and configurations as illustrated in FIG. 4, but may further include other or additional components having a plurality of configurations.

During the implementation, various steps in the above method and various modules in the above apparatus may be implemented by means of an integrated logic circuit in the processor 41 or by means of software. The steps in the method and the units in the apparatus disclosed in the embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 42. The processor 41 reads the information stored in the memory 42 and performs the steps of the above method in combination with the hardware thereof. For brevity of description, the details are not given herein any further.

With the apparatus for bullet screen pushing according to the embodiments of the present disclosure, a user individual tag representing preference of the user may be extracted from a first history record of a target push user, the user individual tag is matched with a maker individual tag of a bullet screen maker, and bullet screens made by the successfully matched bullet screen maker are pushed to the user. In this way, the user may watch and hear his or her interest bullet screens, rather than pushing general bullet screens to the target push user, thereby improving pertinence of bullet screen playing, and enhancing user experience.

Persons of ordinary skill in the art should understand that the discussion of any of the above embodiments is exemplary, and is not intended to imply that the scope of the present disclosure (including the claims) is limited to these exemplary embodiments. The above embodiments, or the technical features in different embodiments may be combined, the steps may be performed in any sort, and various modifications may be made to different aspects of the present disclosure, which are not described in detail for brevity.

In addition, for simplicity of description and discussion and for ease of understanding of the present disclosure without obstacles, well known power/ground connections to integrated circuit (IC) chips and other components may or may not be shown within the drawings provided, for simplicity of illustration and discussion, and so as not to obscure the present disclosure. Further, the apparatus may be shown in a block diagram form in order to avoid obscuring the present disclosure, and also in view of the fact that details with respect to implementation of such block diagram apparatuses are highly dependent upon a platform within which the present disclosure is to be implemented (i.e., such details should be well within understanding of those skilled in the art). Where specific details (e.g., circuits) are set forth in order to describe the exemplary embodiments of the present disclosure, it should be apparent to those skilled in the art that the present disclosure may be practiced without, or with variation of, these specific details. The description is thus to be regarded as illustrative instead of limiting.

Although the present disclosure above has been described with reference to the specific embodiments of the present disclosure, various alternatives, modifications and variations to these embodiments are apparent to those skilled in the art in light of the above description. For example, the discussed embodiments may be used in other memory architectures (for example, a dynamic RAM (DRAM)).

The embodiments of the present disclosure are intended to embrace all such alternatives, modifications, and variations that fall within the spirit and broad scope of the appended claims. Therefore, any omission, modification, equivalent replacement, or improvement made without departing from the spirit and principle of the present disclosure should fall within the protection scope of the present disclosure.

What is claimed is:

1. A method for bullet screen pushing, comprising:
receiving a bullet screen acquisition request for a viewed video from a target push user;
acquiring a first history record of the target push user, and acquiring, via analysis, a user individual tag of the target push user according to the first history record;
acquiring a second history record and/or a maker tag added by another user of at least one bullet screen maker of the video;
acquiring, via analysis, a maker individual tag of the bullet screen maker according to the second history record and/or the maker tag of the bullet screen maker;
matching the user individual tag of the target push user with the maker individual tag of the bullet screen maker; and
pushing a bullet screen made by the bullet screen maker corresponding to the successfully matched maker individual tag to the target push user.

2. The method according to claim 1, wherein the first history record comprises a first history viewing record and a first viewing interaction record of the target push user; and
the acquiring, via analysis, a user individual tag of the target push user according to the first history record comprises:
respectively acquiring, via analysis, a user viewing record individual tag and a user interaction record individual tag of the target push user from the first history viewing record and the first viewing interaction record; and
acquiring a user individual tag comprising the user viewing record individual tag and the user viewing interaction record tag;
and/or,
the second history record comprises a second history viewing record and a second viewing interaction record of the bullet screen maker; and
the acquiring, via analysis, a maker individual tag of the bullet screen maker according to the second history record and/or the maker tag of the bullet screen maker comprises:
respectively acquiring, via analysis, a maker viewing record individual tag and a maker interaction record individual tag of the bullet screen maker from the second history viewing record and the second viewing interaction record; and
acquiring a maker individual tag comprising the maker viewing record individual tag, the maker interaction record individual tag and/or the maker tag.

3. The method according to claim 2, wherein the first history viewing record of the target push user comprises videos viewed by the target push user; the first viewing interaction record comprises albums created by the target push user, comments made by the target push user and users to whom the target push user gives a like;
the acquiring, via analysis, a user individual tag of the target push user according to the first history record specifically comprises:
acquiring video tags of the videos viewed by the target push user, extracting, from the video tags, a video tag with an occurrence frequency higher than a first predetermined frequency, and using the extracted video tag as a user individual video tag;
extracting an album tag according to the albums created by the target push user, and using the extracted album tag as a user individual album tag;
acquiring the comments made by the target push user, extracting a comment tag with an occurrence frequency higher than a second predetermined frequency, and using the extracted comment tag as a user individual comment tag;
acquiring user tags of the users to which the target push user gives a like, and using the acquired user tags as a user individual like-giving tag; and
acquiring a user individual tag comprising the user individual video tag, the user individual album tag, the user individual comment tag and the user individual like-giving tag;
and/or,
the second history viewing record of the bullet screen maker comprises videos viewed by the bullet screen maker; the second viewing interaction record comprises albums created by the bullet screen maker, comments made by the bullet screen maker and users to whom the bullet screen maker gives a like; the maker tag added by another user comprises an individual tag and a work tag;
the acquiring, via analysis, a maker individual tag of the bullet screen maker according to the second history record and/or the maker tag of the bullet screen maker comprises:
acquiring video tags of the videos viewed by bullet screen maker, extracting, from the video tags, a video tag with an occurrence frequency higher than a third predetermined frequency, and using the extracted video tag as a maker individual video tag;
extracting an album tag according to the albums created by bullet screen maker, and using the extracted album tag as a maker individual album tag;
acquiring the comments made by bullet screen maker, extracting a comment tag with an occurrence frequency higher than a second predetermined frequency, and using the extracted comment tag as a maker individual comment tag;
acquiring user tags of the users to which the bullet screen maker gives a like, and using the acquired user tags as a maker individual like-giving tag; and
acquiring a maker individual tag comprising the maker individual video tag, the maker individual album tag, the maker individual comment tag, the maker individual like-giving tag, the individual tag, the work tag and/or the maker tag.

4. The method according to claim 1, wherein the matching the user individual tag of the target push user with the maker individual tag of the bullet screen maker comprises:
comparing one by one the user individual tags of the target push user with the maker individual tags of the bullet screen maker; and
when the quantity of same maker individual tags of the bullet screen maker and user individual tags of the target push user is greater than or equal to a predetermined quantity threshold, judging that the maker individual tags of the bullet screen maker match with the user individual tags of the target push user;
and/or,
the pushing a bullet screen made by the bullet screen maker corresponding to the successfully matched maker individual tag to the target push user comprises:
sorting, according to the quantity of maker individual tags which successfully match with the user individual tags of the target push user, in a descending order bullet screens made by the bullet screen maker corresponding to the successfully matched maker individual tags; and
successively pushing the sorted bullet screens to the target push user.

5. The method according to claim 1, wherein when the bullet screen made by the bullet screen maker to the video is a text bullet screen, the pushing a bullet screen made by the bullet screen maker corresponding to the successfully matched maker individual tag to the target push user comprises:
matching text content of the text bullet screen made by the successfully matched bullet screen maker to the video with a tag of the video; and
pushing the text bullet screen corresponding to the successfully matched text content to the target push user;
and/or,
when the bullet screen made by the bullet screen maker to the video is an audio bullet screen, the step of pushing a bullet screen made by the bullet screen maker corresponding to the successfully matched maker individual tag to the target push user further comprises:
converting audio content of the audio bullet screen made by the successfully matched bullet screen maker to the video into text content;
matching the text content acquired via conversion with a tag of the video; and
pushing the audio bullet screen corresponding to the successfully matched text content to the target push user.

6. An electronic device, comprising:
at least one processor; and
a memory communicably connected with the at least one processor for storing instructions executable by the at least one processor, wherein execution of the instructions by the at least one processor causes the at least one processor to: receive a bullet screen acquisition request for a viewed video from a target push user;
acquire a first history record of the target push user, and acquire, via analysis, a user individual tag of the target push user according to the first history record;
acquire a second history record and/or a maker tag added by another user of at least one bullet screen maker of the video, and acquire, via analysis, a maker individual tag of the bullet screen maker according to the second history record and/or the maker tag of the bullet screen maker;
match the user individual tag of the target push user with the maker individual tag of the bullet screen maker; and
push a bullet screen made by the bullet screen maker corresponding to the successfully matched maker individual tag to the target push user.

7. The electronic device according to claim 6, wherein the first history record comprises a first history viewing record and a first viewing interaction record of the target push user; and the step to acquire, via analysis, a user individual tag of the target push user according to the first history record comprises:
respectively acquiring, via analysis, a user viewing record individual tag and a user interaction record individual tag of the target push user from the first history viewing record and the first viewing interaction record; and
acquiring a user individual tag comprising the user viewing record individual tag and the user viewing interaction record tag;
and/or,
the second history record comprises a second history viewing record and a second viewing interaction record of the bullet screen maker; and
the step to acquire, via analysis, a maker individual tag of the bullet screen maker according to the second history record and/or the maker tag of the bullet screen maker comprises:
respectively acquiring, via analysis, a maker viewing record individual tag and a maker interaction record individual tag of the bullet screen maker from the second history viewing record and the second viewing interaction record; and
acquiring a maker individual tag comprising the maker viewing record individual tag, the maker interaction record individual tag and/or the maker tag.

8. The electronic device according to claim 7, wherein the first history viewing record of the target push user comprises videos viewed by the target push user; the first viewing interaction record comprises albums created by the target push user, comments made by the target push user and users to whom the target push user gives a like; and the step to acquire, via analysis, a user individual tag of the target push user according to the first history record specifically comprises: acquiring video tags of the videos viewed by the target push user, extracting, from the video tags, a video tag with an occurrence frequency higher than a first predetermined frequency, and using the extracted video tag as a user individual video tag;
extracting an album tag according to the albums created by the target push user, and using the extracted album tag as a user individual album tag;
acquiring the comments made by the target push user, extracting a comment tag with an occurrence frequency higher than a second predetermined frequency, and using the extracted comment tag as a user individual comment tag;
acquiring user tags of the users to which the target push user gives a like, and using the acquired user tags as a user individual like-giving tag; and
acquiring a user individual tag comprising the user individual video tag, the user individual album tag, the user individual comment tag and the user individual like-giving tag;
and/or,
the second history viewing record of the bullet screen maker comprises videos viewed by the bullet screen maker; the second viewing interaction record comprises albums created by the bullet screen maker, comments made by the bullet screen maker and users to whom the bullet screen maker gives a like; the maker tag added by another user comprises an individual tag and a work tag; and the step to acquire, via analysis, a maker individual tag of the bullet screen maker according to the second history record and/or the maker tag of the bullet screen maker comprises: acquiring video tags of the videos viewed by bullet screen maker, extracting, from the video tags, a video tag with an occurrence frequency higher than a third predetermined frequency, and using the extracted video tag as a maker individual video tag;
extracting an album tag according to the albums created by bullet screen maker, and using the extracted album tag as a maker individual album tag;
acquiring the comments made by bullet screen maker, extracting a comment tag with an occurrence frequency higher than a second predetermined frequency, and using the extracted comment tag as a maker individual comment tag;
acquiring user tags of the users to which the bullet screen maker gives a like, and using the acquired user tags as a maker individual like-giving tag; and
acquiring a maker individual tag comprising the maker individual video tag, the maker individual album tag, the maker individual comment tag, the maker individual like-giving tag, the individual tag, the work tag and/or the maker tag.

9. The electronic device according to claim 6, wherein the step to match the user individual tag of the target push user with the maker individual tag of the bullet screen maker comprises: comparing one by one the user individual tags of the target push user with the maker individual tags of the bullet screen maker; and
when the quantity of same maker individual tags of the bullet screen maker and user individual tags of the target push user is greater than or equal to a predetermined quantity threshold, judging that the maker individual tags of the bullet screen maker match with the user individual tags of the target push user;
and/or,
the step to push a bullet screen made by the bullet screen maker corresponding to the successfully matched maker individual tag to the target push user comprises: sort, according to the quantity of maker individual tags which successfully match with the user individual tags of the target push user, in a descending order bullet screens made by the bullet screen maker corresponding to the successfully matched maker individual tags; and
successively pushing the sorted bullet screens to the target push user.

10. The electronic device according to claim 6, wherein when the bullet screen made by the bullet screen maker to the video is a text bullet screen, the step to push a bullet screen made by the bullet screen maker corresponding to the successfully matched maker individual tag to the target push user comprises:
matching text content of the text bullet screen made by the successfully matched bullet screen maker to the video with a tag of the video; and
pushing the text bullet screen corresponding to the successfully matched text content to the target push user;
and/or,
when the bullet screen made by the bullet screen maker to the video is an audio bullet screen, the step to push a bullet screen made by the bullet screen maker corresponding to the successfully matched maker individual tag to the target push user comprises:
converting audio content of the audio bullet screen made by the successfully matched bullet screen maker to the video into text content;
matching the text content acquired via conversion with a tag of the video; and
pushing the audio bullet screen corresponding to the successfully matched text content to the target push user.

11. A non-transitory computer-readable storage medium, storage medium storing executable instructions, wherein the execution of the instructions is executed by electronic device, causes the electronic device to:
receive a bullet screen acquisition request for a viewed video from a target push user;
acquire a first history record of the target push user, and acquire, via analysis, a user individual tag of the target push user according to the first history record;
acquire a second history record and/or a maker tag added by another user of at least one bullet screen maker of the video, and acquire, via analysis, a maker individual tag of the bullet screen maker according to the second history record and/or the maker tag of the bullet screen maker;
match the user individual tag of the target push user with the maker individual tag of the bullet screen maker; and
push a bullet screen made by the bullet screen maker corresponding to the successfully matched maker individual tag to the target push user.

12. The non-transitory computer-readable storage medium according to claim 11, wherein the first history record comprises a first history viewing record and a first viewing interaction record of the target push user; and the step to acquire, via analysis, a user individual tag of the target push user according to the first history record comprises:
respectively acquiring, via analysis, a user viewing record individual tag and a user interaction record individual tag of the target push user from the first history viewing record and the first viewing interaction record; and
acquiring a user individual tag comprising the user viewing record individual tag and the user viewing interaction record tag;
and/or,
the second history record comprises a second history viewing record and a second viewing interaction record of the bullet screen maker; and
the step to acquire, via analysis, a maker individual tag of the bullet screen maker according to the second history record and/or the maker tag of the bullet screen maker comprises:
respectively acquiring, via analysis, a maker viewing record individual tag and a maker interaction record individual tag of the bullet screen maker from the second history viewing record and the second viewing interaction record; and
acquiring a maker individual tag comprising the maker viewing record individual tag, the maker interaction record individual tag and/or the maker tag.

13. The non-transitory computer-readable storage medium according to claim 12, wherein the first history viewing record of the target push user comprises videos viewed by the target push user; the first viewing interaction record comprises albums created by the target push user, comments made by the target push user and users to whom the target push user gives a like; and the step to acquire, via analysis, a user individual tag of the target push user according to the first history record specifically comprises:
acquiring video tags of the videos viewed by the target push user, extracting, from the video tags, a video tag with an occurrence frequency higher than a first predetermined frequency, and using the extracted video tag as a user individual video tag;
extracting an album tag according to the albums created by the target push user, and using the extracted album tag as a user individual album tag;
acquiring the comments made by the target push user, extracting a comment tag with an occurrence frequency higher than a second predetermined frequency, and using the extracted comment tag as a user individual comment tag;
acquiring user tags of the users to which the target push user gives a like, and using the acquired user tags as a user individual like-giving tag; and
acquiring a user individual tag comprising the user individual video tag, the user individual album tag, the user individual comment tag and the user individual like-giving tag;
and/or,
the second history viewing record of the bullet screen maker comprises videos viewed by the bullet screen maker; the second viewing interaction record comprises albums created by the bullet screen maker, comments made by the bullet screen maker and users to whom the bullet screen maker gives a like; the maker tag added by another user comprises an individual tag and a work tag; and the step to acquire, via analysis, a maker individual tag of the bullet screen maker according to the second history record and/or the maker tag of the bullet screen maker comprises: acquiring video tags of the videos viewed by bullet screen maker, extracting, from the video tags, a video tag with an occurrence frequency higher than a third predetermined frequency, and using the extracted video tag as a maker individual video tag;
extracting an album tag according to the albums created by bullet screen maker, and using the extracted album tag as a maker individual album tag;
acquiring the comments made by bullet screen maker, extracting a comment tag with an occurrence frequency higher than a second predetermined frequency, and using the extracted comment tag as a maker individual comment tag;
acquiring user tags of the users to which the bullet screen maker gives a like, and using the acquired user tags as a maker individual like-giving tag; and
acquiring a maker individual tag comprising the maker individual video tag, the maker individual album tag, the maker individual comment tag, the maker individual like-giving tag, the individual tag, the work tag and/or the maker tag.

14. The non-transitory computer-readable storage medium according to claim 11, wherein the step to match the user individual tag of the target push user with the maker individual tag of the bullet screen maker comprises: comparing one by one the user individual tags of the target push user with the maker individual tags of the bullet screen maker; and
when the quantity of same maker individual tags of the bullet screen maker and user individual tags of the target push user is greater than or equal to a predetermined quantity threshold, judging that the maker individual tags of the bullet screen maker match with the user individual tags of the target push user;
and/or,
the step to push a bullet screen made by the bullet screen maker corresponding to the successfully matched maker individual tag to the target push user comprises: sort, according to the quantity of maker individual tags which successfully match with the user individual tags of the target push user, in a descending order bullet screens made by the bullet screen maker corresponding to the successfully matched maker individual tags; and
successively pushing the sorted bullet screens to the target push user.

15. The non-transitory computer-readable storage medium according to claim 11, wherein when the bullet screen made by the bullet screen maker to the video is a text bullet screen, the step to push a bullet screen made by the bullet screen maker corresponding to the successfully matched maker individual tag to the target push user comprises:
matching text content of the text bullet screen made by the successfully matched bullet screen maker to the video with a tag of the video; and
pushing the text bullet screen corresponding to the successfully matched text content to the target push user;
and/or,
when the bullet screen made by the bullet screen maker to the video is an audio bullet screen, the step to push a bullet screen made by the bullet screen maker corresponding to the successfully matched maker individual tag to the target push user comprises:
converting audio content of the audio bullet screen made by the successfully matched bullet screen maker to the video into text content;
matching the text content acquired via conversion with a tag of the video; and
pushing the audio bullet screen corresponding to the successfully matched text content to the target push user.
viewed
